(19) United States
(12) Patent Application Publication
(10) Pub. No.: US 2025/0372020 A1
(43) Pub. Date: Dec. 4, 2025

(54) DISPLAY DEVICE, DISPLAY DRIVING DEVICE AND OPERATION METHOD THEREOF

(71) Applicant: Novatek Microelectronics Corp., Hsinchu (TW)

(72) Inventor: Huan-Teng Cheng, Hsinchu City (TW)

(73) Assignee: Novatek Microelectronics Corp., Hsinchu (TW)

(21) Appl. No.: 18/784,883

(22) Filed: Jul. 25, 2024

Related U.S. Application Data
(60) Provisional application No. 63/653,226, filed on May 30, 2024.

(51) Int. Cl. G09G 3/20

(52) U.S. Cl. CPC G09G 3/2092; G09G 2300/026; G09G 2310/027; G09G 2310/04; G09G 2310/08; G09G 2320/0242; G09G 2320/0626; G09G 2330/021; G09G 2340/0435

(57) ABSTRACT

The disclosure provides a display device, a display driving device, and an operation method thereof. The display device includes a host, a display panel, and the display driving device. In a multi-area multi-frame-rate mode, the host transmits partial frame image data to the display driving device in each of frame periods until the multi-area multi-frame-rate mode ends. In the multi-area multi-frame-rate mode, the display driving device selectively feeds back an additional area refresh request to the host. In the multi-area multi-frame-rate mode, in response to the additional area refresh request, the host transmits at least one additional display area image data to the display driving device in addition to transmitting the partial frame image data during at least one corresponding frame period corresponding to the additional area refresh request.

### CROSS-REFERENCE TO RELATED APPLICATION

This application claims the priority benefit of U.S. provisional application Ser. No. 63/653,226, filed on May 30, 2024. The entirety of the above-mentioned patent application is hereby incorporated by reference herein and made a part of this specification.

### BACKGROUND

### Technical Field

The disclosure relates to an electronic device, and more particularly, to a display device, a display driving device, and an operation method thereof.

### Description of Related Art

On a conventional display panel, the entire display panel displays one or more images at a certain same frame rate. In some applications, such as mobile applications, the entire display panel may be divided into multiple display areas, but different display areas display the images at the same frame rate. In many usage scenarios, frequent screen refreshes (e.g., playing animation) are often required only for one display area, while another display area has a static screen and does not require the frequent screen refreshes. When the entire display panel (all the display areas) operates at a high frame rate, power consumption of the display panel is higher. At this time, for the display areas that do not require the frequent screen refreshes, the high frame rate is a waste of power. When the entire display panel (all the display areas) operates at a low frame rate, the power consumption of the display panel is low, but a refresh rate (the frame rate) is too low for the display areas that require the frequent screen refreshes.

A display driving device may control a display panel with a multi-area frame rate (MAFR) through a mask signal to mask out some scan lines, so that some of the display areas of the display panel are not refreshed/updated (in which previous image content is maintained). The display area where the scan lines are masked exhibits low-frame-rate visual effects, while the display area where the scan lines are not masked exhibits high-frame-rate visual effects. However, data transmitted by a host to the display driving device in each of frame periods is full frame data. That is to say, in each of the frame periods, image data of both the low-frame-rate display area and the high-frame-rate display area are transmitted to the display driving device. It is a waste of power and transmission bandwidths to transmit the image data of the display area where the scan lines are masked to the display driving device.

The information disclosed in this BACKGROUND section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides a display device, a display driving device, and an operation method thereof, so as to implement a multi-area multi-frame-rate mode.

In an embodiment of the disclosure, the display device includes a host, a display panel, and a display driving device. The display driving device is coupled between the host and the display panel to drive the display panel based on data provided by the host. In a multi-area multi-frame-rate mode, the host transmits partial frame image data to the display driving device in each of frame periods until the multi-area multi-frame-rate mode ends. In the multi-area multi-frame-rate mode, the display driving device selectively feeds back an additional area refresh request to the host. In the multi-area multi-frame-rate mode, in response to the additional area refresh request, the host transmits at least one additional display area image data to the display driving device in addition to transmitting the partial frame image data in at least one corresponding frame period corresponding to the additional area refresh request.

In an embodiment of the disclosure, the operation method includes the following. in a multi-area multi-frame-rate mode, partial frame image data is transmitted by a host of the display device to a display driving device of the display device in each of frame periods until the multi-area multi-frame-rate mode ends. In the multi-area multi-frame-rate mode, an additional area refresh request is selectively fed back by the display driving device to the host. In the multi-area multi-frame-rate mode, in response to the additional area refresh request, at least one additional display area image data is transmitted by the host to the display driving device in addition to transmitting the partial frame image data in at least one corresponding frame period corresponding to the additional area refresh request.

In an embodiment of the disclosure, the display driving device is configured to drive a display panel. The display driving device includes a gate signal generator, a source driver, and a timing control circuit. The gate signal generator is configured to control a gate driver of the display panel. The gate driver is configured to drive multiple scan lines of the display panel. The source driver is configured to drive multiple data lines of the display panel. The timing control circuit is coupled to the gate signal generator and the source driver. The timing control circuit processes data provided by a host and provides the processed data to the source driver. The timing control circuit controls the gate signal generator. In a multi-area multi-frame-rate mode, the host transmits partial frame image data to the timing control circuit in each of frame periods until the multi-area multi-frame-rate mode ends. In the multi-area multi-frame-rate mode, the timing control circuit selectively feeds back an additional area refresh request to the host. In the multi-area multi-frame-rate mode, in response to the additional area refresh request, the host transmits at least one additional display area image data to the timing control circuit in addition to transmitting the partial frame image data in at least one corresponding frame period corresponding to the additional area refresh request.

Based on the above, when the display device is running in the multi-area multi-frame-rate mode, the host transmits the partial frame image data to the display driving device in each of the frame periods until the multi-area multi-frame-rate mode ends. The partial frame image data refers to the data provided by the host to the display driving device in a certain frame period without the image data of the display area where the scan lines are masked. Since the host does not transmit the image data of the display area where the scan lines are masked to the display driving device, the display device may reduce the power consumption and save transmission bandwidths. In addition, when the host or the display driving device decides to perform the image processing on the partial frame image data and the additional display area image data, by the display driving device feeding back the additional area refresh request to the host, the host may transmit the partial frame image data and the additional display area image data to the display driving device in the corresponding frame period of the additional area refresh request. For example, in some embodiments, the host may transmit the full frame image data to the display driving device in the corresponding frame period, and the display driving device may perform the global refresh on the display panel using the full frame image data in the corresponding frame period (the display driving device does not mask the scan lines of the display panel in the corresponding frame period).

In order for the aforementioned features and advantages of the disclosure to be more comprehensible, embodiments accompanied with drawings are described in detail below.

### BRIEF DESCRIPTION OF THE DRAWINGS

FIG. 1 is a schematic circuit block diagram of a display device according to an embodiment of the disclosure.

FIG. 2 is a schematic flowchart of an operation method of a display device according to an embodiment of the disclosure.

FIG. 3 is a schematic diagram of a host transmitting partial frame image data in a multi-area multi-frame-rate mode according to an embodiment of the disclosure.

FIG. 4 is a schematic diagram of a host transmitting additional display area image data in response to an additional area refresh request in a multi-area multi-frame-rate mode according to an embodiment of the disclosure.

FIG. 5 is a schematic diagram of a host transmitting additional display area image data in response to an additional area refresh request in a multi-area multi-frame-rate mode according to another embodiment of the disclosure.

FIG. 6 is a schematic diagram of a host transmitting additional display area image data in response to an additional area refresh request in a multi-area multi-frame-rate mode according to yet another embodiment of the disclosure.

FIG. 7 is a schematic diagram of a host transmitting additional display area image data in response to an additional area refresh request in a multi-area multi-frame-rate mode according to still another embodiment of the disclosure.

FIG. 8 is a schematic diagram of a host transmitting additional display area image data in response to an additional area refresh request in a multi-area multi-frame-rate mode according to further another embodiment of the disclosure.

FIG. 9 is a schematic diagram of a host transmitting additional display area image data in response to an additional area refresh request in a multi-area multi-frame-rate mode according to yet another embodiment of the disclosure.

FIG. 10 is a schematic diagram of a host transmitting additional display area image data in response to an additional area refresh request in a multi-area multi-frame-rate mode according to still another embodiment of the disclosure.

FIG. 11 is a schematic diagram of a host transmitting additional display area image data in response to an additional area refresh request in a multi-area multi-frame-rate mode according to another embodiment of the disclosure.

FIG. 12 is a schematic diagram of a host transmitting additional display area image data in response to an additional area refresh request in a multi-area multi-frame-rate mode according to further another embodiment of the disclosure.

FIG. 13 is a schematic diagram of a host transmitting additional display area image data in response to an additional area refresh request in a multi-area multi-frame-rate mode according to another embodiment of the disclosure.

FIG. 14 is a schematic diagram of a host transmitting additional display area image data in response to an additional area refresh request in a multi-area multi-frame-rate mode according to another embodiment of the disclosure.

FIG. 15 is a schematic circuit block diagram of a display driving device according to an embodiment of the disclosure.

FIG. 16 is a schematic circuit block diagram of a display driving device according to another embodiment of the disclosure.

### DETAILED DESCRIPTION OF DISCLOSED EMBODIMENTS

The term “coupling (or connection)” as used throughout the present specification (including the claims) may refer to any direct or indirect connection means. For example, if it is described that a first device is coupled (or connected) to a second device, it should be interpreted that the first device can be directly connected to the second device, or the first device can be indirectly connected to the second device through other devices or a certain connection means. The terms “first”, “second” and the like as mentioned throughout the present specification (including the claims) are used to name the elements or to distinguish between different embodiments or scopes, rather than setting an upper or lower limit on the number of the elements or the order of the elements. In addition, wherever possible, elements/components/steps with the same reference numerals in the drawings and embodiments represent the same or similar parts. Cross-reference may be made between the elements/components/steps in different embodiments that are denoted by the same reference numerals or that have the same names.

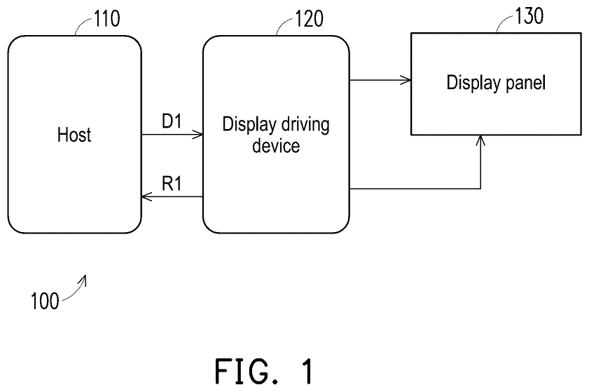

FIG. 1 is a schematic circuit block diagram of a display device 100 according to an embodiment of the disclosure. The display device 100 shown in FIG. 1 includes a host 110, a display driving device 120, and a display panel 130. Based on actual designs and applications, the host 110 may include a central processing unit (CPU), an application processor (AP), or other processors. The host 110 may send data D1 to the display driving device 120 through MIPI a mobile industry processor interface (MIPI) or other communication interfaces. The display driving device 120 is coupled between the host 110 and the display panel 130. The display driving device 120 drives the display panel 130 based on the data D1 provided by the host 110.

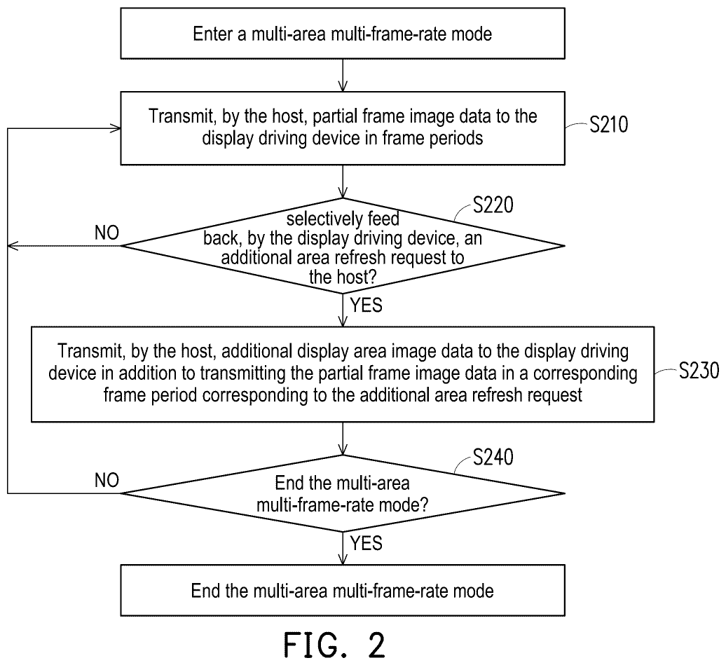

FIG. 2 is a schematic flowchart of an operation method of a display device according to an embodiment of the disclosure. Referring to FIGS. 1 and 2, after entering a multi-area multi-frame-rate mode, the host 110 transmits partial frame image data to the display driving device 120 in each of frame periods (step S210) until the multi-area multi-frame-rate mode ends. In the multi-area multi-frame-rate mode, the display driving device 120 may selectively feed back an additional area refresh request R1 to the host 110 (step S220). According to the actual design, in some embodiments, the display driving device 120 may actively feed back the additional area refresh request R1 to the host 110. In other embodiments, the display driving device 120 may fill the additional area refresh request R1 in a register (not shown) of the display driving device 120, and the host 110 polls the register of the display driving device 120 to obtain the additional area refresh request R1. When the display driving device 120 does not feed back the additional area refresh request R1 to the host 110 (a determination result in step S220 is “No”), the host 110 still transmits the partial frame image data to the display driving device 120 in each of the frame periods (step S210).

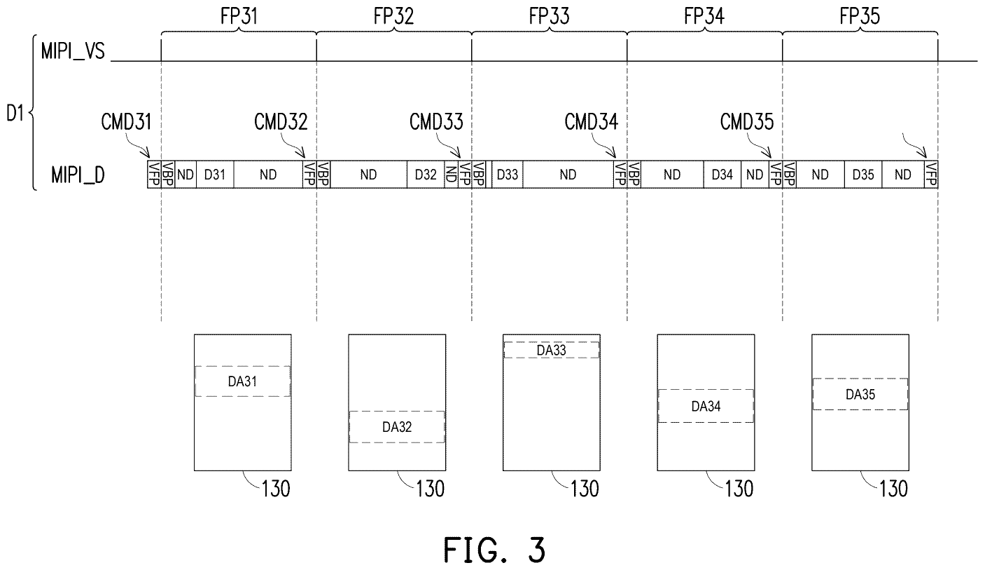

For example, FIG. 3 is a schematic diagram of the host 110 transmitting the partial frame image data in the multi-area multi-frame-rate mode according to an embodiment of the disclosure. A horizontal axis in FIG. 3 represents time. Referring to FIGS. 1 and 3, the data D1 provided by the host 110 includes one or more synchronization information (e.g., vertical synchronization information MIPI_VS) and a data stream MIPI_D. The vertical synchronization information MIPI_VS defines each of frame periods, such as frame periods FP31, FP32, FP33, FP34, and FP35 shown in FIG. 3. In the data stream MIPI_D, a start and an end of each of the frame periods are provided with a vertical back porch VBP and a vertical front porch VFP respectively.

After entering the multi-area multi-frame-rate mode, the host 110 transmits the partial frame image data (non-full frame image data) to the display driving device 120 in each of the frame periods (step S210). The host 110 sends partial refresh position information to the display driving device 120 in each of the frame periods in the multi-area multi-frame-rate mode. In each of the frame periods, the display driving device 120 partially refreshes a high-frame-rate display area of the display panel 130 using the partial frame image data based on the partial refresh position information (other areas maintain old image data). For example, a lower portion of FIG. 3 shows different display areas DA31, DA32, DA33, DA34, and DA35 of the display panel 130. The host 110 sends partial refresh position information CMD31 to the display driving device 120 in a previous frame period in the multi-area multi-frame-rate mode. The partial refresh position information CMD31 carries a position of the display area DA31 of the display panel 130. In the frame period FP31, the display driving device 120 partially refreshes the display area DA31 of the display panel 130 using partial frame image data D31 based on the partial refresh position information CMD31 (other areas DA32 to DA35 maintain the old image data). An icon symbol of “ND” shown in FIG. 3 means no data to reduce data transmission power consumption of the host 110.

By analogy, the display driving device 120 partially refreshes the display area DA32 of the display panel 130 using partial frame image data D32 based on partial refresh position information CMD32 in the frame period FP32, partially refreshes the display area DA33 of the display panel 130 using partial frame image data D33 based on partial refresh position information CMD33 in the frame period FP33, partially refreshes the display area DA34 of the display panel 130 using partial frame image data D34 based on partial refresh position information CMD34 in the frame period FP34, and partially refreshes the display area DA35 of the display panel 130 using partial frame image data D35 based on partial refresh position information CMD35 in the frame period FP35. It should be emphasized that in the embodiment shown in FIG. 3, transmission timings of the partial refresh position information CMD31 to CMD35 are configured in the vertical front porch VFP of each of the frame periods. However, the transmission timings of the partial refresh position information CMD31 to CMD35 may be configured in any position of each of the frame periods according to the actual design.

When the display device 100 runs in the multi-area multi-frame-rate mode, the host 110 transmits the partial frame image data to the display driving device 120 in each of the frame periods until the multi-area multi-frame-rate mode ends. Therefore, data transmission power consumption between the host 110 and the display driving device 120 may be effectively reduced. However, a partial refresh operation of the display panel 130 by the display driving device 120 in the multi-area multi-frame-rate mode may be detrimental to visual experiences of a user in some actual operating situations. For example, in the multi-area multi-frame-rate mode, it is assumed that the host 110 controls the display driving device 120 to adjust the brightness. In a state where the host 110 continues to send the partial frame image data (e.g., pixel data of the high-frame-rate display area), the display driving device 120 may only perform correct dimming on the high-frame-rate display area (other display areas that are not refreshed maintain the old brightness), thus resulting in tearing of the displayed screen. For another example, an adjustment function of color shift actively performed by the display driving device 120 itself is taken as an example. When the display driving device 120 performs color shift compensation on its own, the host 110 does not send the pixel data of the complete frame (which is still the partial frame image data in the multi-area multi-frame-rate mode), and then the display driving device 120 may only perform the color shift compensation on the partially refreshed display area (other display areas that have not been refreshed maintain an old color temperature), thus resulting in poor display effects.

Referring to FIGS. 1 and 2, when the display driving device 120 feeds back the additional area refresh request R1 to the host 110 (the determination result in step S220 is “Yes”), in response to the additional area refresh request R1, the host 110 transmits at least one additional display area image data to the display driving device 120 (step S230) in addition to transmitting the partial frame image data in at least one corresponding frame period corresponding to the additional area refresh request R1. In different application examples, a trigger source in step S220 may be the host 110 or the display driving device 120. For example, in response to the display driving device 120 deciding to perform image processing (e.g., the color shift compensation or other image processing) on the data D1 provided by the host 110 in the multi-area multi-frame-rate mode, the display driving device 120 feeds back the additional area refresh request R1 to the host 110 to request the additional display area image data. For another example, when the host 110 decides to perform the image processing (e.g., brightness adjustment or other image processing) on the data D1, the host 110 sends a display state switching command to the display driving device 120. In response to the display state switching command, the display driving device 120 feeds back the additional area refresh request R1 to the host 110 to request the additional display area image data.

For example (but not limited thereto), the display driving device 120 partially refreshes the high-frame-rate display area of the display panel 130 using the partial frame image data based on the partial refresh position information in each of the frame periods except the corresponding frame period of the additional area refresh request R1. The partial frame image data and the additional display area image data constitute full frame image data. In response to the display driving device 120 sending the additional area refresh request R1, the display driving device 120 ignores the partial refresh position information in the corresponding frame period of the additional area refresh request R1, and the display driving device 120 performs global refresh on the display panel 130 using the full frame image data in the corresponding frame period. Therefore, when the host 110 or the display driving device 120 starts the image processing, a processing range of the image processing may include the full frame image data, and different display areas of the display panel 130 may present a processed/updated image.

After the corresponding frame period of the additional area refresh request R1 ends, in step S240, it is determined whether the multi-area multi-frame-rate mode ends. If the multi-area multi-frame-rate mode has not ended (which is “No” in step S240), the host 110 still transmits the partial frame image data to the display driving device 120 in each of the frame periods (step S210).

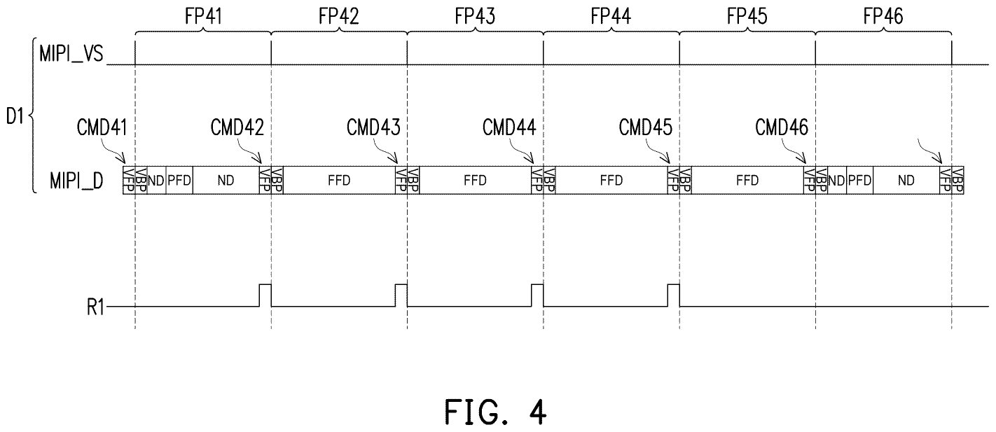

FIG. 4 is a schematic diagram of the host 110 transmitting the additional display area image data in response to the additional area refresh request R1 in the multi-area multi-frame-rate mode according to an embodiment of the disclosure. A horizontal axis in FIG. 4 represents the time. The vertical synchronization information MIPI_VS, a frame period FP41, a frame period FP42, a frame period FP43, a frame period FP44, a frame period FP45, a frame period FP46, the data stream MIPI_D, partial refresh position information CMD41, partial refresh position information CMD42, partial refresh position information CMD43, partial refresh position information CMD44, partial refresh position information CMD45, and partial refresh position information CMD46 shown in FIG. 4 may refer to relevant descriptions of the vertical synchronization information MIPI_VS, the frame periods FP31 to FP35, the data stream MIPI_D, and the partial refresh position information CMD31 to CMD35 shown in FIG. 3 and make analogies. Therefore, the same details will not be repeated in the following. In the data stream MIPI_D shown in FIG. 4, an icon symbol of “VFP” represents the vertical front porch, an icon symbol of “VBP” represents the vertical back porch, the icon symbol of “ND” represents none data, and an icon symbol of “PFD” represents the partial frame image data, and an icon symbol of “FFD” represents the full frame image data. The partial frame image data PFD shown in FIG. 4 may refer to the relevant descriptions of the partial frame image data D31 to D35 shown in FIG. 3 and make analogies. Therefore, the same details will not be repeated in the following.

Referring to FIGS. 1 and 4, the display driving device 120 partially refreshes the high-frame-rate display area of the display panel 130 using the partial frame image data PFD based on the partial refresh position information (e.g., CMD41 and CMD46) in each of the frame periods (e.g., the frame periods FP41 and FP46) except the corresponding frame periods FP42 to FP45 of the additional area refresh request R1. In response to the display driving device 120 deciding to perform the image processing (e.g., the color shift compensation or other image processing) on the data D1 provided by the host 110 in the multi-area multi-frame-rate mode, the display driving device 120 feeds back the additional area refresh request R1 to the host 110 to request the additional display area image data. In the embodiment shown in FIG. 4, each of pulse signals of the additional area refresh request R1 corresponds to one frame period for transmitting the full frame image data FFD. For example, in response to the host 110 receiving the pulse signal of the additional area refresh request R1 in the current frame period FP41 in the multi-area multi-frame-rate mode, the host 110 transmits the full frame image data FFD in the next frame period FP42 after the current frame period FP41 to the display driving device 120. It should be emphasized that in the embodiment shown in FIG. 4, the display driving device 120 feeds back the pulse signal of the additional area refresh request R1 to the host 110 in the vertical front porch VFP of the frame period. However, a pulse timing of the additional area refresh request R1 may be configured at any position of the frame period according to the actual design.

In response to the display driving device 120 sending the additional area refresh request R1, the host 110 transmits the full frame image data FFD to the display driving device 120 in the corresponding frame periods FP42 to FP45 of the additional area refresh request R1. The display driving device 120 ignores the partial refresh position information CMD42 to CMD45 in the corresponding frame periods FP42 to FP45 of the additional area refresh request R1. The display driving device 120 performs the image processing (e.g., the color shift compensation or other image processing) on the full frame image data FFD provided by the host 110, and the driving device 120 performs the global refresh on the display panel 130 using the processed full frame image data FFD in corresponding frame periods FP42 to FP45. When the display driving device 120 starts the image processing, the processing range of the image processing may include the full frame image data FFD, so the different display areas of the display panel 130 may present the processed/updated image.

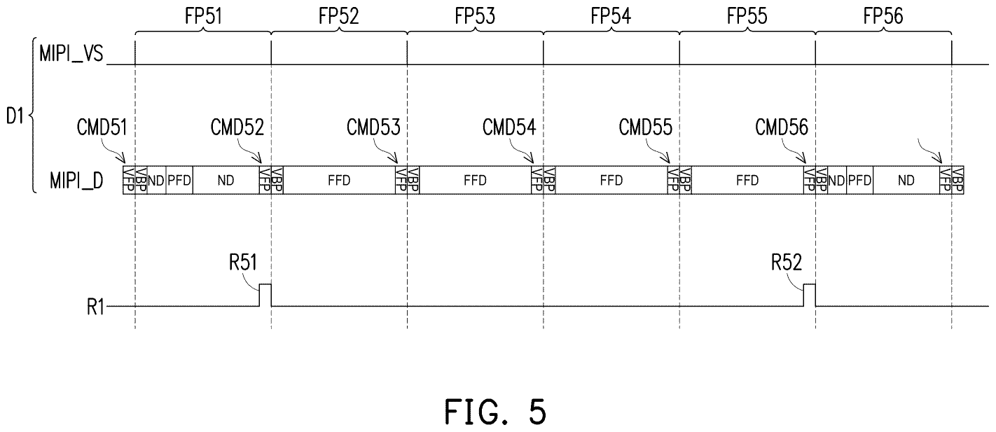

FIG. 5 is a schematic diagram of the host 110 transmitting the additional display area image data in response to the additional area refresh request R1 in the multi-area multi-frame-rate mode according to another embodiment of the disclosure. A horizontal axis in FIG. 5 represents the time. The vertical synchronization information MIPI_VS, a frame period FP51, a frame period FP52, a frame period FP53, a frame period FP54, a frame period FP55, a frame period FP56, the data stream MIPI_D, partial refresh position information CMD51, partial refresh position information CMD52, partial refresh position information CMD53, partial refresh position information CMD54, partial refresh position information CMD55, and partial refresh position information CMD56 shown in FIG. 5 may refer to the relevant descriptions of the vertical synchronization information MIPI_VS, the frame periods FP31 to FP35, the data stream MIPI_D, and the partial refresh position information CMD31 to CMD35 shown in FIG. 3 and make analogies. Therefore, the same details will not be repeated in the following. The vertical front porch VFP, the vertical back porch VBP, the none data ND, the partial frame image data PFD, the full frame image data FFD, and the additional area refresh request R1 shown in FIG. 5 may refer to the relevant descriptions in FIG. 4 and make analogies. Therefore, the same details will not be repeated in the following.

A difference from the embodiment shown in FIG. 4 lies in a waveform of the additional area refresh request R1 shown in FIG. 5. The additional area refresh request R1 shown in FIG. 5 includes a start pulse signal R51 used to define a start frame period corresponding to the frame periods FP52 to FP55 and a stop pulse signal R52 used to define a stop frame period corresponding to the frame periods FP52 to FP55. In response to the display driving device 120 sending the additional area refresh request R1, the host 110 transmits the full frame image data FFD to the display driving device 120 in the corresponding frame periods FP52 to FP55 of the additional area refreshing request R1. The display driving device 120 ignores the partial refresh position information CMD52 to CMD55 in the corresponding frame periods FP52 to FP55. The display driving device 120 performs the image processing (e.g., the color shift compensation or other image processing) on the full frame image data FFD provided by the host 110, and the display driving device 120 performs the global refresh on the display panel 130 using the processed full frame image data FFD in the corresponding frame periods FP52 to FP55. Therefore, when the display driving device 120 starts the image processing, the different display areas of the display panel 130 may present the processed/updated image.

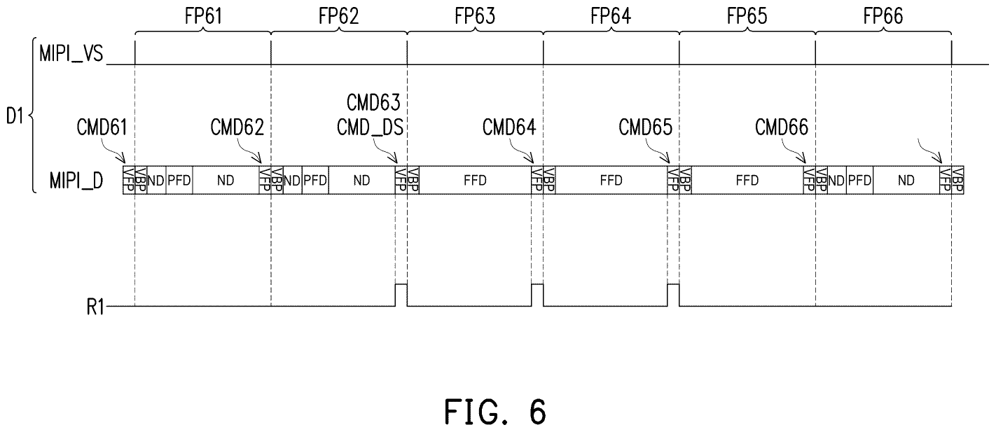

FIG. 6 is a schematic diagram of the host 110 transmitting the additional display area image data in response to the additional area refresh request R1 in the multi-area multi-frame-rate mode according to yet another embodiment of the disclosure. A horizontal axis in FIG. 6 represents the time. The vertical synchronization information MIPI_VS, a frame period FP61, a frame period FP62, a frame period FP63, a frame period FP64, a frame period FP65, a frame period FP66, the data stream MIPI_D, partial refresh position information CMD61, partial refresh position information CMD62, partial refresh position information CMD63, partial refresh position information CMD64, partial refresh position information CMD65, and partial refresh position information CMD66 shown in FIG. 6 may refer to the relevant descriptions of the vertical synchronization information MIPI_VS, the frame periods FP31 to FP35, the data stream MIPI_D, and the partial refresh position information CMD31 to CMD35 shown in FIG. 3 and make analogies. Therefore, the same details will not be repeated in the following. The vertical front porch VFP, the vertical back porch VBP, the none data ND, the partial frame image data PFD, the full frame image data FFD, and the additional area refresh request R1 shown in FIG. 6 may refer to the relevant descriptions in FIG. 4 and make analogies. Therefore, the same details will not be repeated in the following.

In the embodiment shown in FIG. 6, when the host 110 decides to perform the image processing (e.g., the brightness adjustment or other image processing) on the data D1, the host 110 sends a display state switching command CMD_DS to the display driving device 120. In response to the display state switching command CMD_DS, the display driving device 120 feeds back the additional area refresh request R1 to the host 110 to request the additional display area image data. The display driving device 120 partially refreshes the high-frame-rate display area of the display panel 130 using the partial frame image data PFD based on the partial refresh position information (e.g., CMD61, CMD62, and CMD66) in each of the frame periods (e.g., the frame periods FP61, FP62, and FP66) except the corresponding frame periods FP63 to FP65 of the additional area refresh request R1. In response to the host 110 deciding to perform the image processing (e.g., the brightness adjustment or other image processing) on the data D1 in the multi-area multi-frame-rate mode, the host 110 sends the display state switching command CMD_DS to the display driving device 120.

In response to the display state switching command CMD_DS, the display driving device 120 feeds back the additional area refresh request R1 to the host 110 to request the additional display area image data. For example, in response to the display driving device 120 receiving the display state switching command CMD_DS in the current frame period FP62 in the multi-area multi-frame-rate mode, the display driving device 120 feeds back the first pulse signal of the additional area refresh request R1 to the host 110 in the current frame period FP62. In response to the display driving device 120 sending the additional area refresh request R1, the host 110 transmits the full frame image data FFD to the display driving device 120 in the corresponding frame periods FP63 to FP65 of the additional area refresh request R1. The display driving device 120 ignores the partial refresh position information CMD63 to CMD65, and the display driving device 120 performs the global refresh on the display panel 130 using the full frame image data FFD in the corresponding frame periods FP63 to FP65. When the host 110 starts the image processing, the processing range of the image processing may include the full frame image data FFD, so the different display areas of the display panel 130 may present the processed/updated image.

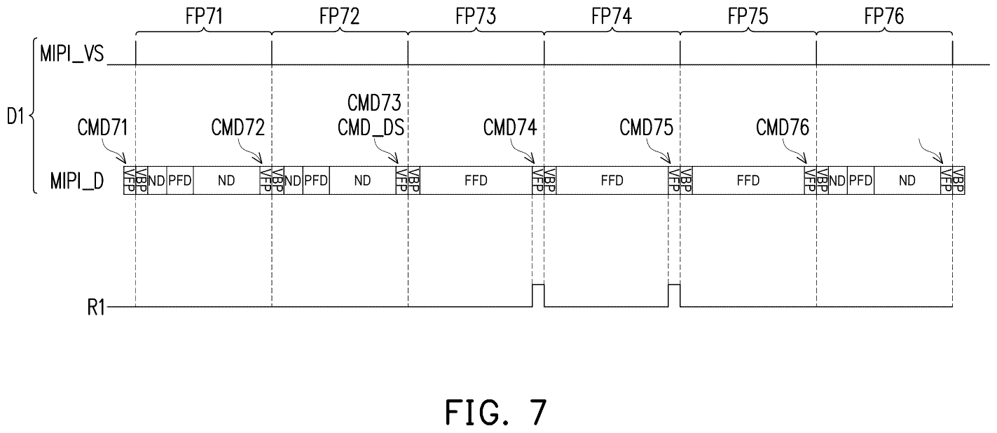

FIG. 7 is a schematic diagram of the host 110 transmitting the additional display area image data in response to the additional area refresh request R1 in the multi-area multi-frame-rate mode according to still another embodiment of the disclosure. A horizontal axis in FIG. 7 represents the time. The vertical synchronization information MIPI_VS, a frame period FP71, a frame period FP72, a frame period FP73, a frame period FP74, a frame period FP75, a frame period FP76, the data stream MIPI_D, partial refresh position information CMD71, partial refresh position information CMD72, partial refresh position information CMD73, partial refresh position information CMD74, partial refresh position information CMD75, and partial refresh position information CMD76 shown in FIG. 7 may refer to the relevant descriptions of the vertical synchronization information MIPI_VS, the frame periods FP31 to FP35, the data stream MIPI_D, and the partial refresh position information CMD31 to CMD35 shown in FIG. 3 and make analogies. Therefore, the same details will not be repeated in the following. The vertical front porch VFP, the vertical back porch VBP, the none data ND, the partial frame image data PFD, the full frame image data FFD, and the additional area refresh request R1 shown in FIG. 7 may refer to the relevant descriptions in FIG. 4 or 6 and make analogies, while the display state switching command CMD_DS shown in FIG. 7 may refer to relevant descriptions of the display state switching command CMD_DS shown in FIG. 6 and make analogies. Therefore, the same details will not be repeated in the following.

A difference from the embodiment shown in FIG. 6 lies in timings of the additional area refresh request R1 shown in FIG. 7. In the embodiment shown in FIG. 7, when the host 110 decides to perform the image processing (e.g., the brightness adjustment or other image processing) on the data D1, the host 110 sends the display state switching command CMD_DS to the display driving device 120 in the frame period FP72, and the host 110 transmits the full frame image data FFD to the display driving device 120 in the frame period FP73. In response to the display driving device 120 receiving the display state switching command CMD_DS in the current frame period FP72 in the multi-area multi-frame-rate mode, the display driving device 120 feeds back the first pulse signal of the additional area refresh request R1 to the host 110 in the next frame period FP73 after the current frame period FP72. In response to the display driving device 120 sending the additional area refresh request R1, the host 110 transmits the full frame image data FFD to the display driving device 120 in the corresponding frame periods FP74 to FP75 of the additional area refresh request R1. The display driving device 120 ignores the partial refresh position information CMD74 to CMD75 in the corresponding frame periods FP74 to FP75, and the display driving device 120 performs the global refresh on the display panel 130 using the full frame image data FFD in the corresponding frame periods FP74 to FP75. When the host 110 starts the image processing, the processing range of the image processing may include the full frame image data FFD, so the different display areas of the display panel 130 may present the processed/updated image.

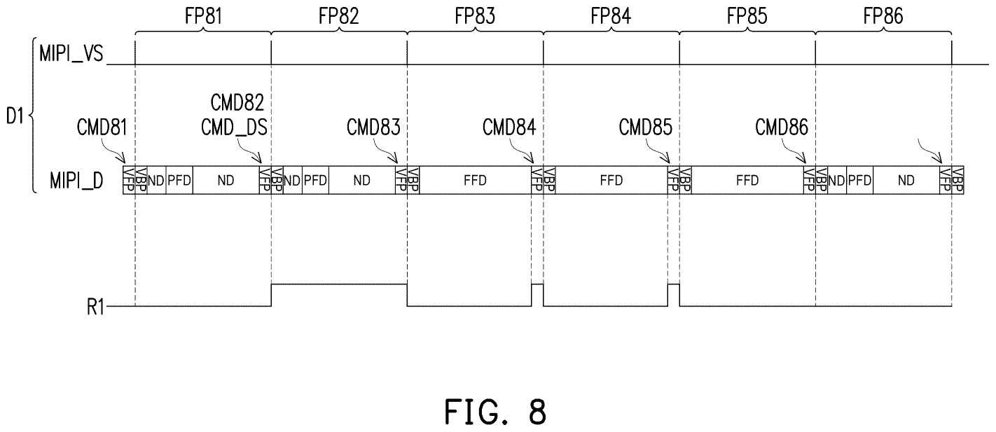

FIG. 8 is a schematic diagram of the host 110 transmitting the additional display area image data in response to the additional area refresh request R1 in the multi-area multi-frame-rate mode according to further another embodiment of the disclosure. A horizontal axis in FIG. 8 represents the time. The vertical synchronization information MIPI_VS, a frame period FP81, a frame period FP82, a frame period FP83, a frame period FP84, a frame period FP85, a frame period FP86, the data stream MIPI_D, partial refresh position information CMD81, partial refresh position information CMD82, partial refresh position information CMD83, partial refresh position information CMD84, partial refresh position information CMD85, and partial refresh position information CMD86 shown in FIG. 8 may refer to the relevant descriptions of the vertical synchronization information MIPI_VS, the frame periods FP31 to FP35, the data stream MIPI_D, and the partial refresh position information CMD31 to CMD35 shown in FIG. 3 and make analogies. Therefore, the same details will not be repeated in the following. The vertical front porch VFP, the vertical back porch VBP, the none data ND, the partial frame image data PFD, the full frame image data FFD, and the additional area refresh request R1 shown in FIG. 8 may refer to the relevant descriptions in FIG. 4, 6, or 7 and make analogies, while the display state switching command CMD_DS shown in FIG. 8 may refer to the relevant descriptions of the display state switching command CMD_DS shown in FIG. 6 and make analogies. Therefore, the same details will not be repeated in the following.

A difference from the embodiment shown in FIG. 6 lies in the waveform of the additional area refresh request R1 shown in FIG. 8. In the embodiment shown in FIG. 8, when the host 110 decides to perform the image processing (e.g., the brightness adjustment or other image processing) on the data D1, the host 110 sends the display state switching command CMD_DS to the display driving device 120 in the frame period FP81. In response to the display driving device 120 receiving the display state switching command CMD_DS in the current frame period FP81 in the multi-area multi-frame-rate mode, the display driving device 120 feeds back the first pulse signal of the additional area refresh request R1 to the host 110 in the next frame period FP82 after the current frame period FP81. In response to the display driving device 120 sending the additional area refresh request R1, the host 110 transmits the full frame image data FFD to the display driving device 120 in the corresponding frame periods FP83 to FP85 of the additional area refresh request R1. The display driving device 120 ignores the partial refresh position information CMD83 to CMD85 in the corresponding frame periods FP83 to FP85, and the display driving device 120 performs the global refresh on the display panel 130 using the full frame image data FFD in the corresponding frame periods FP83 to FP85. When the host 110 starts the image processing, the processing range of the image processing may include the full frame image data FFD, so the different display areas of the display panel 130 may present the processed/updated image.

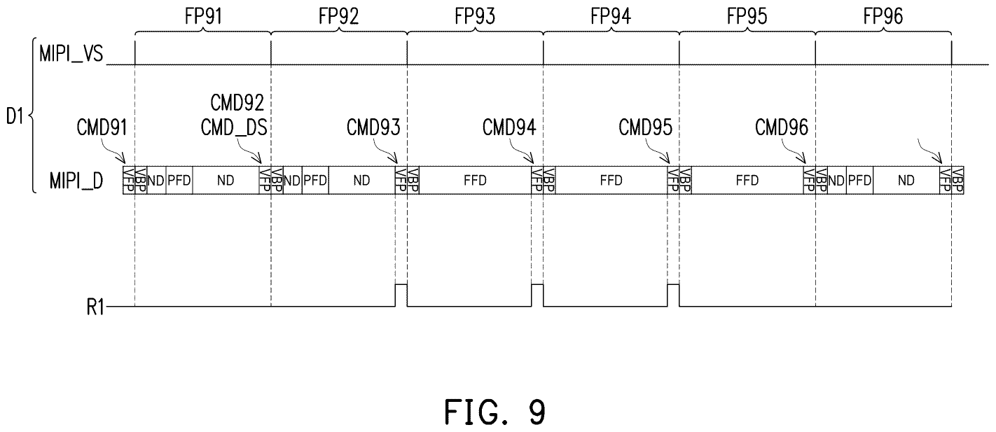

FIG. 9 is a schematic diagram of the host 110 transmitting the additional display area image data in response to the additional area refresh request R1 in the multi-area multi-frame-rate mode according to yet another embodiment of the disclosure. A horizontal axis in FIG. 9 represents the time. The vertical synchronization information MIPI_VS, a frame period FP91, a frame period FP92, a frame period FP93, a frame period FP94, a frame period FP95, a frame period FP96, the data stream MIPI_D, partial refresh position information CMD91, partial refresh position information CMD92, partial refresh position information CMD93, partial refresh position information CMD94, partial refresh position information CMD95, and partial refresh position information CMD96 shown in FIG. 9 may refer to the relevant descriptions of the vertical synchronization information MIPI_VS, the frame periods FP31 to FP35, the data stream MIPI_D, and the partial refresh position information CMD31 to CMD35 shown in FIG. 3 and make analogies. Therefore, the same details will not be repeated in the following. The vertical front porch VFP, the vertical back porch VBP, the none data ND, the partial frame image data PFD, the full frame image data FFD, and the additional area refresh request R1 shown in FIG. 9 may refer to the relevant descriptions in FIG. 4, 6, 7, or 8 and make analogies, while the display state switching command CMD_DS shown in FIG. 9 may refer to the relevant descriptions of the display state switching command CMD_DS shown in FIG. 8 and make analogies. Therefore, the same details will not be repeated in the following.

A difference from the embodiment shown in FIG. 8 lies in the waveform of the additional area refresh request R1 shown in FIG. 9. In the embodiment shown in FIG. 9, when the host 110 decides to perform the image processing (e.g., the brightness adjustment or other image processing) on the data D1, the host 110 sends the display state switching command CMD_DS to the display driving device 120 in the frame period FP91. In response to the display driving device 120 receiving the display state switching command CMD_DS in the current frame period FP91 in the multi-area multi-frame-rate mode, the display driving device 120 feeds back the first pulse signal of the additional area refresh request R1 to the host 110 in the next frame period FP92 after the current frame period FP91. In response to the display driving device 120 sending the additional area refresh request R1, the host110 running in the multi-area multi-frame-rate mode transmits the full frame image data FFD to the display driving device 120 in the corresponding frame periods FP93 to FP95 of the additional area refresh request R1. The display driving device 120 ignores the partial refresh position information CMD93 to CMD95 in the corresponding frame periods FP93 to FP95, and the display driving device 120 performs the global refresh on the display panel 130 using the full frame image data FFD in the corresponding frame periods FP93 to FP95. When the host 110 starts the image processing, the processing range of the image processing may include the full frame image data FFD, so the different display areas of the display panel 130 may present the processed/updated image.

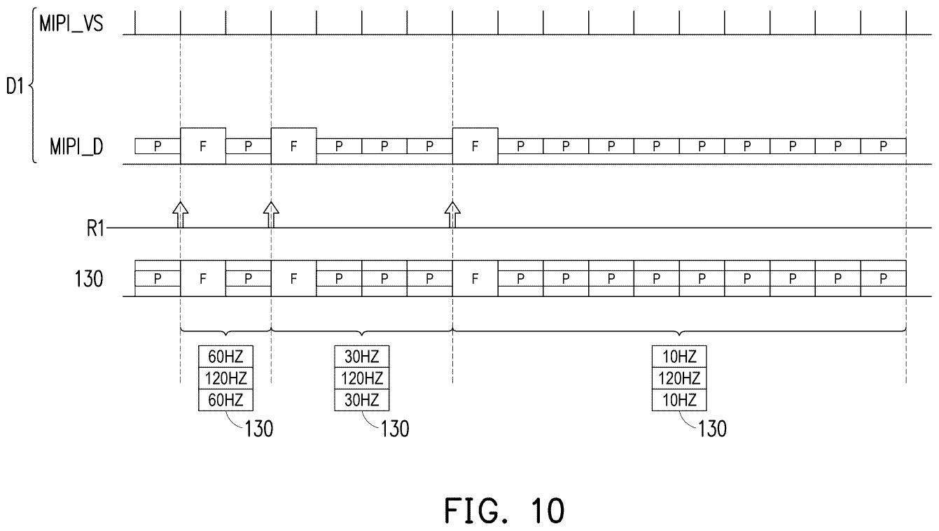

FIG. 10 is a schematic diagram of the host 110 transmitting the additional display area image data in response to the additional area refresh request R1 in the multi-area multi-frame-rate mode according to still another embodiment of the disclosure. A horizontal axis in FIG. 10 represents the time. The vertical synchronization information MIPI_VS and the data stream MIPI_D shown in FIG. 10 may refer to the relevant descriptions of the vertical synchronization information MIPI_VS and the data stream MIPI_D shown in FIG. 3 and make analogies. Therefore, the same details will not be repeated in the following. An icon symbol of “P” shown in FIG. 10 represents the partial frame image data, and an icon symbol of “F” represents the full frame image data. By adjusting the pulse timing of the additional area refresh request R1, in the embodiment shown in FIG. 10, a frame rate of the low-frame-rate display area of the display panel 130 may be gradually adjusted. For example, it is assumed that a middle portion of the display panel 130 is the high-frame-rate display area, and upper and lower portions of the display panel 130 are the low-frame-rate display areas. A frame rate of the high-frame-rate display area of the display panel 130 is assumed to be 120 Hz. By adjusting the pulse timing of the additional area refresh request R1, the frame rate of the low-frame-rate display area of the adjusted display panel 130 as shown in FIG. 10 may be gradually reduced from 60 Hz, 30 Hz to 10 Hz.

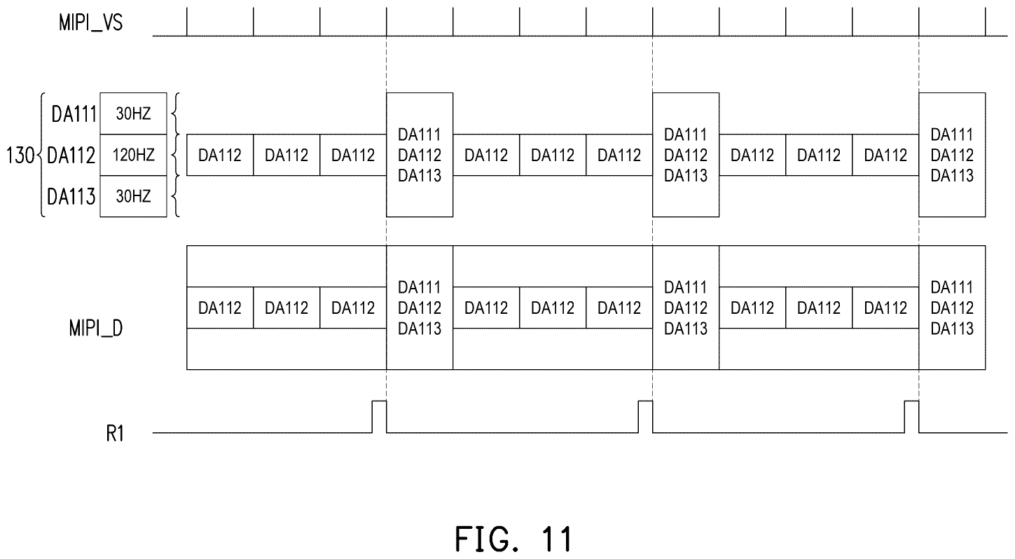

FIG. 11 is a schematic diagram of the host 110 transmitting the additional display area image data in response to the additional area refresh request R1 in the multi-area multi-frame-rate mode according to another embodiment of the disclosure. A horizontal axis in FIG. 11 represents the time. The vertical synchronization information MIPI_VS and the data stream MIPI_D shown in FIG. 11 may refer to the relevant descriptions of the vertical synchronization information MIPI_VS and the data stream MIPI_D shown in FIG. 3 and make analogies. Therefore, the same details will not be repeated in the following. In the embodiment shown in FIG. 11, the display panel 130 includes display areas DA111, DA112, and DA113. It is assumed that the display area DA112 is a high-frame-rate display area (in which a frame rate thereof is assumed to be 120 Hz), and the display areas DA111 and DA113 are low-frame-rate display areas (in which a frame rate thereof is assumed to be 30 Hz). When the display driving device 120 does not feed back the additional area refresh request R1 to the host 110, the host 110 transmits the partial frame image data (image data of the display area DA112) to the display driving device 120 in each of the frame periods. Therefore, the display driving device 120 partially refreshes the high-frame-rate display area (the display area DA112) of the display panel 130 using the partial frame image data (other areas DA111 and DA113 maintain the old image data).

In response to the display driving device 120 sending the pulse signal of the additional area refresh request R1, the host 110 transmits the full frame image data (image data of the display areas DA111, DA112, and DA113) to the display driving device 120 in the corresponding frame period of the additional area refresh request R1. Therefore, the display driving device 120 performs the global refresh on the display panel 130 using the full frame image data. In the embodiment shown in FIG. 11, one global refresh frame is matched with three partial refresh frames. Therefore, when a frame rate of the display area DA112 (the high-frame-rate display area) of the display panel 130 is 120 Hz, a frame rate of the display areas DA111 and DA113 (the low-frame-rate display area) is 30 Hz.

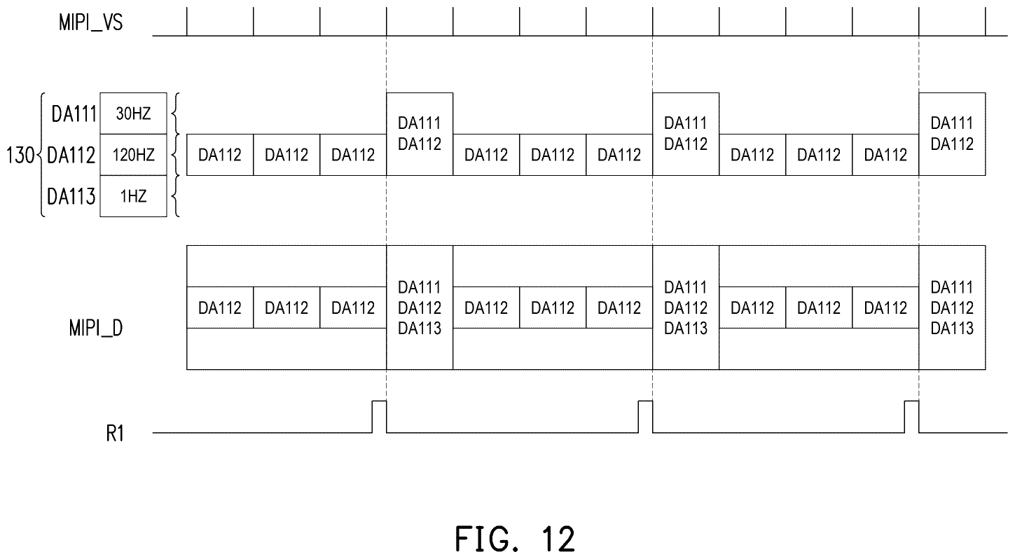

FIG. 12 is a schematic diagram of the host 110 transmitting the additional display area image data in response to the additional area refresh request R1 in the multi-area multi-frame-rate mode according to further another embodiment of the disclosure. A horizontal axis in FIG. 12 represents the time. The vertical synchronization information MIPI_VS and the data stream MIPI_D shown in FIG. 12 may refer to the relevant descriptions of the vertical synchronization information MIPI_VS and the data stream MIPI_D shown in FIG. 3 and make analogies. Therefore, the same details will not be repeated in the following. In the embodiment shown in FIG. 12, the display panel 130 includes the display areas DA111, DA112, and DA113. It is assumed that the frame rate of the display area DA111 is 30 Hz, the frame rate of the display area DA112 is 120 Hz, and the frame rate of the display area DA113 is 1 Hz. For the embodiment shown in FIG. 12, reference may be made to relevant descriptions of the embodiment shown in FIG. 11. A difference from the embodiment shown in FIG. 11 is that when the host 110 provides the full frame image data (the image data of the display areas DA111, DA112, and DA113) to the display driving device 120 in a partial frame period, the display driving device 120 discards the image data of the display area DA113 provided by the host 110, and partially refreshes the display panel 130 using the image data of the display areas DA111 and DA112.

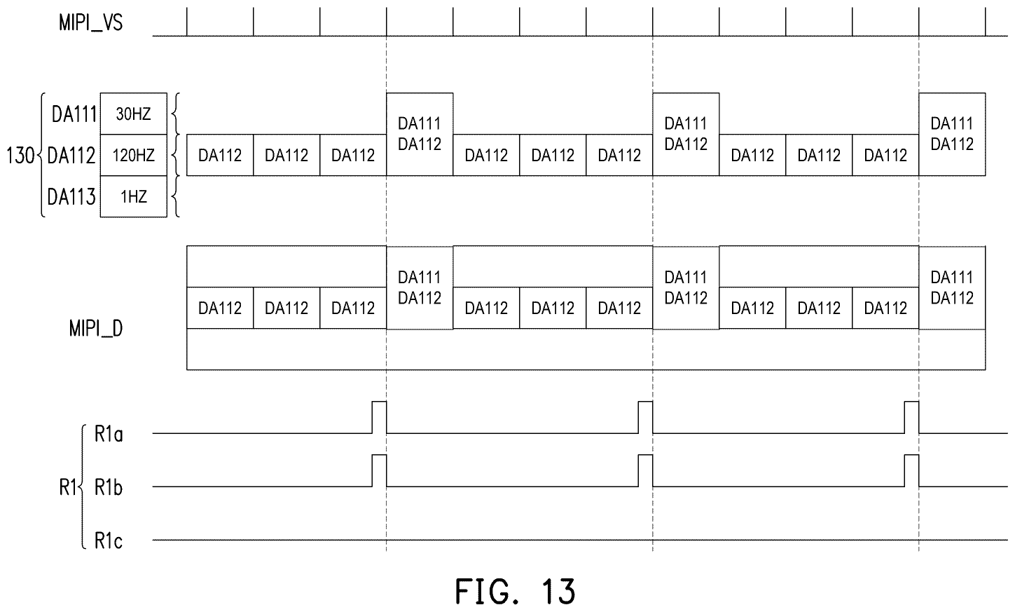

FIG. 13 is a schematic diagram of the host 110 transmitting the additional display area image data in response to the additional area refresh request R1 in the multi-area multi-frame-rate mode according to another embodiment of the disclosure. A horizontal axis in FIG. 13 represents the time. The vertical synchronization information MIPI_VS and the data stream MIPI_D shown in FIG. 13 may refer to the relevant descriptions of the vertical synchronization information MIPI_VS and the data stream MIPI_D shown in FIG. 3 and make analogies. Therefore, the same details will not be repeated in the following. In the embodiment shown in FIG. 13, the display panel 130 includes the display areas DA111, DA112, and DA113. It is assumed that the frame rate of the display area DA111 is 30 Hz, the frame rate of the display area DA112 is 120 Hz, and the frame rate of the display area DA113 is 1 Hz. In the embodiment shown in FIG. 13, the additional area refresh request R1 includes multiple area requests R1a, R1b, and R1c corresponding to the different display areas DA111, DA112, and DA113 of the display panel 130. In response to a designated area request among the area requests R1a, R1b, and R1c, the host 110 transmits the additional display area image data corresponding to the designated area request to the display driving device 120. For example, in response to pulse signals the designated area requests R1a and R1b among the area requests R1a, R1b, and R1c, the host 110 transmits the image data (the additional display area image data) of the display areas DA111 and DA112 corresponding to the designated area requests R1a and R1b to the display driving device 120. The display driving device 120 partially refreshes the display panel 130 using the image data of the display areas DA111 and DA112.

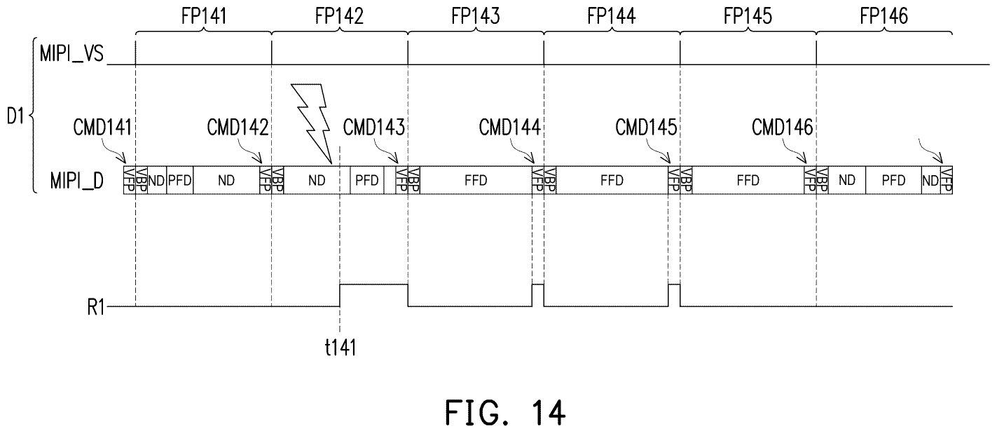

FIG. 14 is a schematic diagram of the host 110 transmitting the additional display area image data in response to the additional area refresh request R1 in the multi-area multi-frame-rate mode according to another embodiment of the disclosure. A horizontal axis in FIG. 14 represents the time. The vertical synchronization information MIPI_VS, a frame period FP141, a frame period FP142, a frame period FP143, a frame period FP144, a frame period FP145, a frame period FP146, the data stream MIPI_D, partial refresh position information CMD141, partial refresh position information CMD142, partial refresh position information CMD143, partial refresh position information CMD144, partial refresh position information CMD145, and partial refresh position information CMD146 shown in FIG. 14 may refer to the relevant descriptions of the vertical synchronization information MIPI_VS, the frame periods FP31 to FP35, the data stream MIPI_D, and the partial refresh position information CMD31 to CMD35 shown in FIG. 3 and make analogies. Therefore, the same details will not be repeated in the following. The vertical front porch VFP, the vertical back porch VBP, the none data ND, the partial frame image data PFD, the full frame image data FFD, and the additional area refresh request R1 shown in FIG. 4 may refer to the relevant descriptions in FIG. 4 and make analogies. Therefore, the same details will not be repeated in the following.

When the display driving device 120 detects that an electrostatic discharge (ESD) event occurs, the display driving device 120 may notify the host 110 by sending the additional area refresh request R1. For example, assuming that the display driving device 120 detects that the ESD event occurs at a time point t141, the display driver 120 may feed back the first pulse signal of the additional area refresh request R1 to the host 110 in the frame period FP142, so as to request the host 110 to send the full frame image data FFD in the next frame period for recovery. In response to the display driving device 120 sending the additional area refresh request R1, the host 110 running in the multi-area multi-frame-rate mode transmits the full frame image data FFD to the display driving device 120 in the corresponding frame periods FP143 to FP145 of the additional area refresh request R1. The display driving device 120 ignores the partial refresh position information CMD143 to CMD145 in the corresponding frame periods FP143 to FP145, and the display driving device 120 performs the global refresh on the display panel 130 using the full frame image data FFD in the corresponding frame periods FP143 to FP145. Therefore, after the ESD event occurs, the display driving device 120 may use the full frame image data FFD for recovery, so that the different display areas of the display panel 130 may present the updated/restored image.

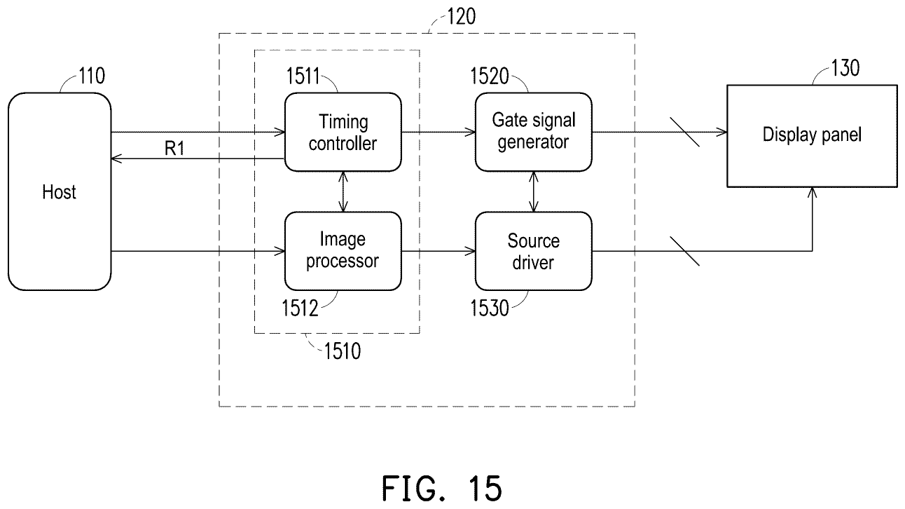

FIG. 15 is a schematic circuit block diagram of the display driving device 120 according to an embodiment of the disclosure. The host 110, the display driving device 120, and the display panel 130 shown in FIG. 15 may refer to relevant descriptions in FIG. 1. The display driving device 120 shown in FIG. 15 may be used as one of many implementation examples of the display driving device 120 shown in FIG. 1. In the embodiment shown in FIG. 15, the display driving device 120 includes a timing control circuit 1510, a gate signal generator 1520, and a source driver 1530. The source driver 1530 is used to drive multiple data lines (not shown) of the display panel 130. The gate signal generator 1520 is used to control a gate driver (not shown) of the display panel 130. The gate driver is used to drive multiple scan lines (not shown) of the display panel 130. Based on the actual design and application, the gate driver of the display panel 130 may include a gate on panel (GOP) driving circuit, a gate on array (GOA) driving circuit, or other gate drivers.

The timing control circuit 1510 is coupled to the gate signal generator 1520 and the source driver 1530. In the multi-area multi-frame-rate mode, the host 110 transmits the partial frame image data to the timing control circuit in each of the frame periods until the multi-area multi-frame-rate mode ends. In the multi-area multi-frame-rate mode, the timing control circuit 1510 selectively feeds back the additional area refresh request R1 to the host 110. In response to the additional area refresh request R1, the host 110 running in the multi-area multi-frame-rate mode transmits the at least one additional display area image data to the timing control circuit 1510 in the at least one corresponding frame period corresponding to the additional area refresh request R1. The timing control circuit 1510 processes the data provided by the host 110 and provides the processed data to the source driver 1530. The source driver 1530 drives the data lines (not shown) of the display panel 130 based on the processed data provided by the timing control circuit 1510. The timing control circuit 1510 controls the gate signal generator 1520 based on timing data provided by the host 110 to generate a gate timing signal for the gate driver (not shown) of the display panel 130.

In some application examples, the host 110 sends the partial refresh position information to the timing control circuit 1510 in each of the frame periods in the multi-area multi-frame-rate mode. The timing control circuit 1510 partially refreshes the high-frame-rate display area of the display panel 130 using the partial frame image data through the source driver 1530 based on the partial refresh position information in each of the frame periods except the at least one corresponding frame period.

In some application examples, the partial frame image data and the at least one additional display area image data constitute the full frame image data. In response to the timing control circuit 1510 sending the additional area refresh request R1, the timing control circuit 1510 ignores the partial refresh position information provided by the host 110 in the at least one corresponding frame period, and the timing control circuit 1510 performs the global refresh on the display panel 130 using the full frame image data provided by the host 110 through the source driver 1530 in the at least one corresponding frame period.

In some application examples, in response to the timing control circuit 1510 deciding to perform the image processing (e.g., the color shift compensation or other image processing) on the data provided by the host 110 in the multi-area multi-frame-rate mode, the timing control circuit 1510 feeds back the additional area refresh request R1 to the host 110 to request the at least one additional display area image data.

In some application examples, in response to the host 110 deciding to perform the image processing (e.g., the brightness adjustment or other image processing) on the data provided by the host 110 to the timing control circuit 1510 in the multi-area multi-frame-rate mode, the host 110 sends the display state switching command to the timing control circuit 1510. In response to the display state switching command, the timing control circuit 1510 feeds back the additional area refresh request R1 to the host 110 to request the at least one additional display area image data.

In some application examples, in response to the timing control circuit 1510 receiving the display state switching command sent by the host 110 in the current frame period in the multi-area multi-frame-rate mode, the timing control circuit 1510 feeds back the additional area refresh request R1 to the host 110 in the current frame period.

In some application examples, in response to the timing control circuit 1510 receiving the display state switching command sent by the host 110 in the current frame period in the multi-area multi-frame-rate mode, the timing control circuit 1510 feeds back the additional area refresh request R1 to the host 110 in the next frame period after the current frame period.

In some application examples, the partial frame image data and the at least one additional display area image data constitute the full frame image data, and the additional area refresh request R1 includes the pulse signal. In response to the host 110 receiving the pulse signal in the current frame period in the multi-area multi-frame-rate mode, the host 110 transmits the full frame image data to the timing control circuit 1510 in the next frame period after the current frame period. For example (but not limited thereto), the timing control circuit 1510 feeds back the pulse signal to the host 110 in the vertical front porch VFP of the current frame period.

In some application examples, the additional area refresh request R1 includes the area requests corresponding to the different display areas of the display panel 130. In response to one designated area request among the area requests, the host 110 transmits the additional display area image data corresponding to the designated area request to the timing control circuit 1510.

In the embodiment shown in FIG. 15, the timing control circuit 1510 includes a timing controller 1511 and an image processor 1512. According to different designs, in some embodiments, the display driving device 120, the timing control circuit 1510, the timing controller 1511, and/or the image processor 1512 may be implemented as hardware circuits. In other embodiments, the display driving device 120, the timing control circuit 1510, the timing controller 1511, and/or the image processor 1512 may be implemented in a combination of hardware, firmware, and software (i.e., program).

In terms of hardware, the display driving device 120, the timing control circuit 1510, the timing controller 1511, and/or the image processor 1512 may be implemented as logic circuits on integrated circuits. For example, related functions of the display driving device 120, the timing control circuit 1510, the timing controller 1511, and/or the image processor 1512 may be implemented in one or more hardware controllers, microcontrollers, hardware processors, microprocessors, application-specific integrated circuits (ASIC), digital signal processors (DSP), field programmable logic gate arrays (FPGA), central processing units (CPU), and/or various logic blocks, modules, and circuits in other processing units. The related functions of the display driving device 120, the timing control circuit 1510, the timing controller 1511, and/or the image processor 1512 may be implemented as the hardware circuits using hardware description languages (e.g., Verilog HDL or VHDL) or other suitable programming languages, such as various logic blocks, modules, and circuits in the integrated circuits.

In terms of software and/or firmware, the related functions of the display driving device 120, the timing control circuit 1510, the timing controller 1511, and/or the image processor 1512 may be implemented as programming codes. For example, the display driving device 120, the timing control circuit 1510, the timing controller 1511, and/or the image processor 1512 are implemented using general programming languages (e.g., C, C++, or assembly language) or other suitable programming languages. The programming codes may be recorded/stored in a “non-transitory machine-readable storage medium”. In some embodiments, the non-transitory machine-readable storage medium includes, for example, a semiconductor memory and/or a storage device. An electronic device (e.g., the CPU, the hardware controller, the microcontroller, the hardware processor, or the microprocessor) may read and execute the programming codes from the non-transitory machine-readable storage medium, thereby achieving the related functions of the display driving device 120, the timing control circuit 1510, the timing controller 1511, and/or the image processor 1512.

The timing controller 1511 is coupled to the gate signal generator 1520. The image processor 1512 is coupled to the timing controller 1511 and the source driver 1530. The image processor 1512 processes the data provided by the host 110 and provides the processed data to the source driver 1530. In the embodiment shown in FIG. 15, the timing controller 1511 selectively feeds back the additional area refresh request R1 to the host 110 in the multi-area multi-frame-rate mode. In response to the additional area refresh request R1, the host 110 running in the multi-area multi-frame-rate mode transmits the at least one additional display area image data to the image processor 1512 in at least one corresponding frame period corresponding to the additional area refresh request R1.

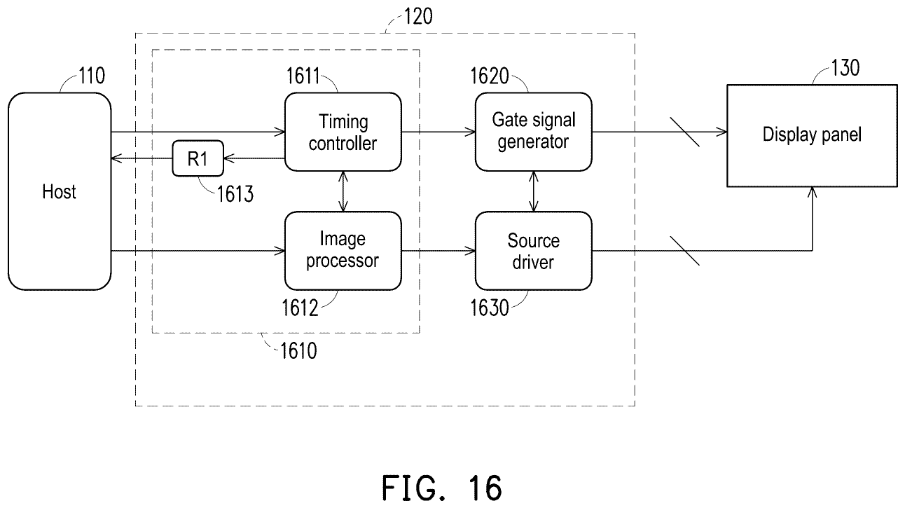

FIG. 16 is a schematic circuit block diagram of the display driving device 120 according to another embodiment of the disclosure. The host 110, the display driving device 120, and the display panel 130 shown in FIG. 16 may refer to relevant descriptions in FIG. 1. The display driving device 120 shown in FIG. 16 may be used as one of many implementation examples of the display driving device 120 shown in FIG. 1. In the embodiment shown in FIG. 16, the display driving device 120 includes a timing control circuit 1610, a gate signal generator 1620, and a source driver 1630. The host 110, the display panel 130, the timing control circuit 1610, the gate signal generator 1620, and the source driver 1630 shown in FIG. 16 may refer to relevant descriptions of the host 110, the display panel 130, the timing control circuit 1510, the gate signal generator 1520, and the source driver 1530 shown in FIG. 15 and make analogies. Therefore, the same details will not be repeated in the following.

In some application examples, the partial frame image data provided by the host 110 and the at least one additional display area image data constitute the full frame image data. In the application example shown in FIG. 16, the timing control circuit 1610 includes a timing controller 1611, an image processor 1612, and a register 1613. The timing controller 1611 selectively fills the additional area refresh request R1 into the register 1613 in the multi-area multi-frame-rate mode. The host 110 may poll the register 1613 of the timing control circuit 1510 to obtain the additional area refresh request R1. In response to the host 110 receiving the additional area refresh request R1 in the current frame period in the multi-area multi-frame rate mode, the host 110 transmits the full frame image data to the timing control circuit 1510 in the next frame period after the current frame period.

Based on the above, when the display device 100 is running in the multi-area multi-frame-rate mode, the host 110 transmits the partial frame image data to the display driving device 120 in each of the frame periods until the multi-area multi-frame-rate mode ends. The partial frame image data refers to the data provided by the host 110 to the display driving device 120 in a certain frame period without the image data of the display area where the scan lines are masked. Since the host 110 does not transmit the image data of the display area where the scan lines are masked to the display driving device 120, the display device 100 may reduce the power consumption and save transmission bandwidths. In addition, when the host 110 or the display driving device 120 decides to perform the image processing on the partial frame image data and the additional display area image data, by the display driving device 120 feeding back the additional area refresh request R1 to the host 110, the host 110 may transmit the partial frame image data and the additional display area image data to the display driving device 120 in the corresponding frame period of the additional area refresh request R1. For example, in some embodiments, the host 110 may transmit the full frame image data to the display driving device 120 in the corresponding frame period, and the display driving device 120 may perform the global refresh on the display panel 130 using the full frame image data in the corresponding frame period (the display driving device 120 does not mask the scan lines of the display panel in the corresponding frame period). Therefore, when the host 110 or the display driving device 120 starts the image processing, the processing range of the image processing may include the full frame image data, and the different display areas of the display panel 130 may present the processed/updated image.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A display device comprising:
a host;
a display panel; and
a display driving device coupled between the host and the display panel to drive the display panel based on data provided by the host, wherein
in a multi-area multi-frame-rate mode, the host transmits partial frame image data to the display driving device in each of frame periods until the multi-area multi-frame-rate mode ends;
in the multi-area multi-frame-rate mode, the display driving device selectively feeds back an additional area refresh request to the host; and
in the multi-area multi-frame-rate mode, in response to the additional area refresh request, the host transmits at least one additional display area image data to the display driving device in addition to transmitting the partial frame image data in at least one corresponding frame period corresponding to the additional area refresh request.

2. The display device according to claim 1, wherein the host comprises an application processor.

3. The display device according to claim 1, wherein the host sends partial refresh position information to the display driving device in the multi-area multi-frame-rate mode, and the display driving device partially refreshes a high-frame-rate display area of the display panel using the partial frame image data based on the partial refresh position information in another frame period except the at least one corresponding frame period.

4. The display device according to claim 3, wherein the partial frame image data and the at least one additional display area image data constitute full frame image data,
in response to the display driving device sending the additional area refresh request, the display driving device ignores the partial refresh position information in the at least one corresponding frame period, and the display driving device performs global refresh on the display panel using the full frame image data in the at least one corresponding frame period.

5. The display device according to claim 1, wherein in response to the display driving device deciding to perform image processing on the data provided by the host in the multi-area multi-frame-rate mode, the display driving device feeds back the additional area refresh request to the host to request the at least one additional display area image data.

6. The display device according to claim 5, wherein the image processing comprises color shift compensation.

7. The display device according to claim 1, wherein
in response to the host deciding to perform image processing on the data provided by the host to the display driving device in the multi-area multi-frame-rate mode, the host sends a display state switching command to the display driving device; and
in response to the display state switching command, the display driving device feeds back the additional area refresh request to the host to request the at least one additional display area image data.

8. The display device according to claim 7, wherein the image processing comprises brightness adjustment.

9. The display device according to claim 7, wherein in response to the display driving device receiving the display state switching command in a current frame period in the multi-area multi-frame-rate mode, the display driving device feeds back the additional area refresh request to the host in the current frame period.

10. The display device according to claim 7, wherein in response to the display driving device receiving the display state switching command in a current frame period in the multi-area multi-frame-rate mode, the display driving device feeds back the additional area refresh request to the host in a next frame period after the current frame period.

11. The display device according to claim 1, wherein the partial frame image data and the at least one additional display area image data constitute full frame image data, the additional area refresh request comprises a pulse signal, and
in response to the host receiving the pulse signal in a current frame period in the multi-area multi-frame-rate mode, the host transmits the full frame image data to the display driving device in a next frame period after the current frame period.

12. The display device according to claim 11, wherein the display driving device feeds back the pulse signal to the host in a vertical front porch of the current frame period.

13. The display device according to claim 1, wherein the partial frame image data and the at least one additional display area image data constitute full frame image data, and the host polls a register of the display driving device to obtain the additional area refresh request, and
in response to the host receiving the additional area refresh request in a current frame period in the multi-area multi-frame-rate mode, the host transmits the full frame image data to the display driving device in a next frame period after the current frame period.

14. The display device according to claim 1, wherein the display driving device comprises:
a gate signal generator configured to control a gate driver of the display panel, wherein the gate driver is configured to drive a plurality of scan lines of the display panel;
a source driver configured to drive a plurality of data lines of the display panel; and
a timing control circuit coupled to the gate signal generator and the source driver, wherein the timing control circuit processes the data provided by the host and provides the processed data to the source driver, the timing control circuit controls the gate signal generator,
the timing control circuit selectively feeds back the additional area refresh request to the host in the multi-area multi-frame-rate mode; and
in response to the additional area refresh request, the host transmits the at least one additional display area image data to the timing control circuit in the at least one corresponding frame period corresponding to the additional area refresh request in the multi-area multi-frame-rate mode.

15. The display device according to claim 14, wherein the timing control circuit comprises:
a timing controller coupled to the gate signal generator; and
an image processor coupled to the timing controller and the source driver, wherein the image processor processes the data provided by the host and provides the processed data to the source driver,
the timing controller selectively feeds back the additional area refresh request to the host in the multi-area multi-frame-rate mode; and
in response to the additional area refresh request, the host transmits the at least one additional display area image data to the image processor in the at least one corresponding frame period corresponding to the additional area refresh request in the multi-area multi-frame-rate mode.

16. The display device according to claim 1, wherein the additional area refresh request comprises a plurality of area requests corresponding to different display areas of the display panel, and in response to a designated area request among the area requests, the host transmits the additional display area image data corresponding to the designated area request to the display driving device.

17. An operation method of a display device, comprising:
in a multi-area multi-frame-rate mode, transmitting partial frame image data to a display driving device of the display device in each of frame periods by a host of the display device until the multi-area multi-frame-rate mode ends;
in the multi-area multi-frame-rate mode, selectively feeding back an additional area refresh request by the display driving device to the host; and
in the multi-area multi-frame-rate mode, in response to the additional area refresh request, transmitting at least one additional display area image data by the host to the display driving device in addition to transmitting the partial frame image data in at least one corresponding frame period corresponding to the additional area refresh request.

18. The operation method according to claim 17, further comprising:
sending, by the host, partial refresh position information to the display driving device in the multi-area multi-frame-rate mode; and
partially refreshing, by the display driving device, a high-frame-rate display area of the display panel using the partial frame image data based on the partial refresh position information in another frame period except the at least one corresponding frame period.

19. The operation method according to claim 18, wherein the partial frame image data and the at least one additional display area image data constitute full frame image data, and the operation method further comprises:
in response to the display driving device sending the additional area refresh request, ignoring the partial refresh position information in the at least one corresponding frame period, and performing global refresh on the display panel using the full frame image data in the at least one corresponding frame period by the display driving device.

20. The operation method according to claim 17, further comprising:
in response to the display driving device deciding to perform image processing on the data provided by the host in the multi-area multi-frame-rate mode, feeding back the additional area refresh request by the display driving device to the host to request the at least one additional display area image data.

21. The operation method according to claim 20, wherein the image processing comprises color shift compensation.

22. The operation method according to claim 17, further comprising:
in response to the host deciding to perform image processing on the data provided by the host to the display driving device in the multi-area multi-frame-rate mode, sending a display state switching command by the host to the display driving device; and
in response to the display state switching command, feeding back the additional area refresh request by the display driving device to the host to request the additional display area image data.

23. The operation method according to claim 22, wherein the image processing comprises brightness adjustment.

24. The operation method according to claim 22, further comprising:
in response to the display driving device receiving the display state switching command in a current frame period in the multi-area multi-frame-rate mode, feeding back the additional area refresh request by the display driving device to the host in the current frame period.

25. The operation method according to claim 22, further comprising:
in response to the display driving device receiving the display state switching command in a current frame period in the multi-area multi-frame-rate mode, feeding back the additional area refresh request by the display driving device to the host in a next frame period after the current frame period.

26. The operation method according to claim 17, wherein the partial frame image data and the at least one additional display area image data constitute full frame image data, the additional area refresh request comprises a pulse signal, and the operation method further comprises:
in response to the host receiving the pulse signal in a current frame period in the multi-area multi-frame-rate mode, transmitting the full frame image data by the host to the display driving device in a next frame period after the current frame period.

27. The operation method according to claim 26, further comprising:
feeding back, by the display driving device, the pulse signal to the host in a vertical front porch of the current frame period.

28. The operation method according to claim 17, wherein the partial frame image data and the at least one additional display area image data constitute full frame image data, and the operation method further comprises:
polling, by the host, a register of the display driving device to obtain the additional area refresh request, and
in response to the host receiving the additional area refresh request in the current frame period in the multi-area multi-frame-rate mode, transmitting the full frame image data by the host to the display driving device in a next frame period after the current frame period.

29. The operation method according to claim 17, wherein the additional area refresh request comprises a plurality of area requests corresponding to different display areas of the display panel, and the operation method further comprises:
in response to a designated area request among the area requests, transmitting the additional display area image data corresponding to the designated area request by the host to the display driving device.

30. A display driving device configured to drive a display panel, wherein the display driving device comprises:
a gate signal generator configured to control a gate driver of the display panel, wherein the gate driver is configured to drive a plurality of scan lines of the display panel;
a source driver configured to drive a plurality of data lines of the display panel; and
a timing control circuit coupled to the gate signal generator and the source driver, wherein the timing control circuit processes data provided by a host and provides the processed data to the source driver, the timing control circuit controls the gate signal generator,
in a multi-area multi-frame-rate mode, the host transmits partial frame image data to the timing control circuit in each of frame periods until the multi-area multi-frame-rate mode ends;
in the multi-area multi-frame-rate mode, the timing control circuit selectively feeds back an additional area refresh request to the host; and
in the multi-area multi-frame-rate mode, in response to the additional area refresh request, the host transmits at least one additional display area image data to the timing control circuit in addition to transmitting the partial frame image data in at least one corresponding frame period corresponding to the additional area refresh request.

31. The display driving device according to claim 30, wherein the host sends partial refresh position information to the timing control circuit in the multi-area multi-frame-rate mode, and the timing control circuit partially refreshes a high-frame-rate display area of the display panel using the partial frame image data through the source driver based on the partial refresh position information in another frame period except the at least one corresponding frame period.

32. The display driving device according to claim 31, wherein the partial frame image data and the at least one additional display area image data constitute full frame image data, and
in response to the timing control circuit sending the additional area refresh request, the timing control circuit ignores the partial refresh position information in the at least one corresponding frame period, and the timing control circuit performs global refresh on the display panel using the full frame image data through the source driver in the at least one corresponding frame period.

33. The display driving device according to claim 30, wherein in response to the timing control circuit deciding to perform image processing on the data provided by the host in the multi-area multi-frame-rate mode, the timing control circuit feeds back the additional area refresh request to the host to request the at least one additional display area image data.

34. The display driving device according to claim 33, wherein the image processing comprises color shift compensation.

35. The display driving device according to claim 30, wherein
in response to the host deciding to perform image processing on the data provided by the host to the timing control circuit in the multi-area multi-frame-rate mode, the host sends a display state switching command to the timing control circuit; and
in response to the display state switching command, the timing control circuit feeds back the additional area refresh request to the host to request the at least one additional display area image data.

36. The display driving device according to claim 35, wherein the image processing comprises brightness adjustment.

37. The display driving device according to claim 35, wherein in response to the timing control circuit receiving the display state switching command in a current frame period in the multi-area multi-frame-rate mode, the timing control circuit feeds back the additional area refresh request to the host in the current frame period.

38. The display driving device according to claim 35, wherein in response to the timing control circuit receiving the display state switching command in a current frame period in the multi-area multi-frame-rate mode, the timing control circuit feeds back the additional area refresh request to the host in a next frame period after the current frame period.

39. The display driving device according to claim 30, wherein the partial frame image data and the at least one additional display area image data constitute full frame image data, the additional area refresh request comprises a pulse signal, and
in response to the host receiving the pulse signal in a current frame period in the multi-area multi-frame-rate mode, the host transmits the full frame image data to the timing control circuit in a next frame period after the current frame period.

40. The display driving device according to claim 39, wherein the timing control circuit feeds back the pulse signal to the host in a vertical front porch of the current frame period.

41. The display driving device according to claim 30, wherein the partial frame image data and the at least one additional display area image data constitute full frame image data, the host polls a register of the timing control circuit to obtain the additional area refresh request, and
in response to the host receiving the additional area refresh request in a current frame period in the multi-area multi-frame-rate mode, the host transmits the full frame image data to the timing control circuit in a next frame period after the current frame period.

42. The display driving device according to claim 30, wherein the timing control circuit comprises:
a timing controller coupled to the gate signal generator; and
an image processor coupled to the timing controller and the source driver, wherein the image processor processes the data provided by the host and provides the processed data to the source driver,
the timing controller selectively feeds back the additional area refresh request to the host in the multi-area multi-frame-rate mode; and
in response to the additional area refresh request, the host transmits the at least one additional display area image data to the image processor in the at least one corresponding frame period corresponding to the additional area refresh request in the multi-area multi-frame-rate mode.

43. The display driving device according to claim 30, wherein the additional area refresh request comprises a plurality of area requests corresponding to different display areas of the display panel, and in response to a designated area request among the area requests, the host transmits the additional display area image data corresponding to the designated area request to the timing controller.
